(19) United States
(12) Patent Application Publication
(10) Pub. No.: US 2016/0221383 A1
(43) Pub. Date: Aug. 4, 2016

(54) Method of Forming Three-Dimensional Features on an Interior Surface of an Article

(71) Applicants: Yi-Chuan CHENG, Changhua County (TW); Kuo-Ching CHIANG, New Taipei City (TW)

(72) Inventors: Yi-Chuan CHENG, Changhua County (TW); Kuo-Ching CHIANG, New Taipei City (TW)

(21) Appl. No.: 15/011,427

(22) Filed: Jan. 29, 2016

(30) Foreign Application Priority Data
Jan. 30, 2015 (TW) 104103266

(51) Int. Cl. B44C 1/18; B22F 5/00; B22F 3/105; B29C 67/00; B28B 1/00

(52) U.S. Cl. CPC B44C 1/18; B29C 67/0055; B29C 67/0077; B29C 67/0066; B28B 1/001; B22F 3/1055; B22F 5/00; B33Y 10/00

(57) ABSTRACT

A method of forming a three-dimensional object on the interior surface of an article includes preparing a model with computer-aided design or computer software and dividing the model into layer-by-layer cross-section files; reading cross-section information in the layer-by-layer cross-section files by a spraying device; spraying and depositing liquid or powdered sprayed material layer by layer according to the cross-section information by the spraying device to form cross-sections, wherein the thickness and the resolution in the direction of the plane of the cross-section deposited by the spraying device are calculated in dpi or micrometers; and depositing and adhering the sprayed material layer by layer to form an article and depositing an interior surface three-dimensional object on an interior surface of the article according to the interior surface three-dimensional object information by the spraying device without use of injection molding, demolding and trimming procedures.

### CROSS-REFERENCE TO RELATED APPLICATIONS

The present application claims the benefit of TAIWAN Patent Application Serial Number 104103266 filed on Jan. 30, 2015, which is herein incorporated by reference.

### TECHNICAL FIELD

The present invention relates to a manufacturing method, and particularly to a method of forming three-dimensional features on an interior surface of an article.

### BACKGROUND OF RELATED ARTS

Various containers or articles have functional or decorative three-dimensional designs in the interior thereof. A traditional manufacturing method employs two molds to manufacture separately and then performs demolding to manufacture the interior designs or the three-dimensional objects. However, such method needs to manufacture the molds and align two molds. Furthermore, the molds may have ragged edges and thus the ragged edges have to be trimmed. Besides, some material cannot be manufactured by injection molding.

### SUMMARY

One object of the present invention is to provide a method of forming three-dimensional features on an interior surface of an article.

A method of forming three-dimensional features on an interior surface of an article includes preparing a model with computer-aided design or computer software and dividing the model into layer-by-layer cross-section files; reading cross-section information in the layer-by-layer cross-section files by a spraying device; spraying and depositing liquid or powdered sprayed material layer by layer according to the cross-section information by the spraying device to form cross-sections, wherein the thickness and the resolution in the direction of the plane of the cross-section deposited by the spraying device are calculated in dpi or micrometers; and depositing and adhering the sprayed material layer by layer to form an article and depositing an interior surface three-dimensional object on an interior surface of the article according to the interior surface three-dimensional object information by the spraying device without use of injection molding, demolding and trimming procedures.

The layer-by-layer cross-section files may employ standard triangle language (STL) file format, virtual reality modeling language (VRML) file format or WRL file format. The thickness of the cross-sections may be about 10 micrometers to 100 micrometers. The spraying diameter of the spraying may be about 50 to 100 micrometers.

The spraying may utilize selective laser sintering, fused deposition modeling, stereolithography apparatus, laminated object manufacturing, direct metal laser sintering, digital light processing or fused filament fabrication. The sprayed material may be thermoplastic material, metal powder, ceramic powder, alloy, resin, paper, metal film or thin plastic film.

The present invention does not need the injection molding, demolding and trimming procedures, so as to facilitate the manufacture of the interior three-dimensional sculptures. The article may be containers. For example, the articles may include cups, bowls, kettles, bottles, pans, tubs, spheres, lampshades or light bulbs.

### BRIEF DESCRIPTION OF THE DRAWINGS

The aforementioned aspects and the advantages of the present invention may be readily understood by the following detailed descriptions, and the spirit of the present invention may be easily understood by the descriptions and the attached drawings below, wherein:

FIG. 1 is a diagram in accordance with one embodiment of the present invention.

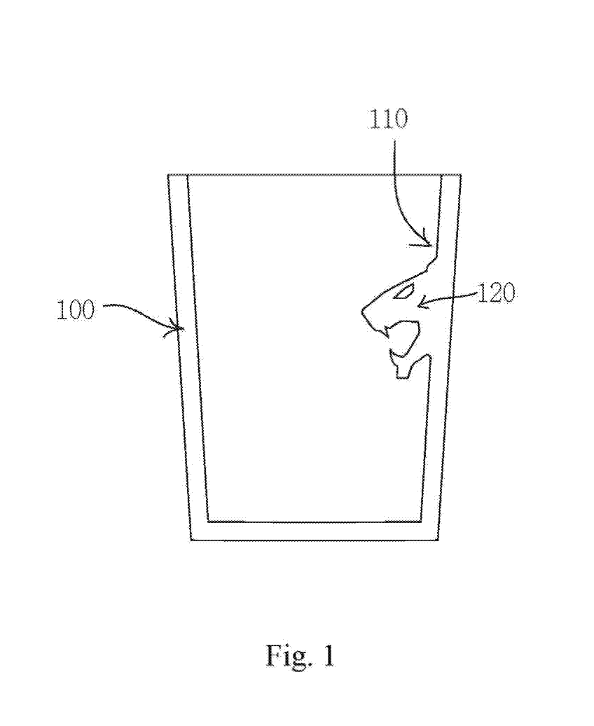

### DETAILED DESCRIPTION

In the following descriptions, various specific details are provided for comprehensive understanding of the embodiments of the present invention. The present invention will now be described in detail with the preferred embodiments and the attached drawings, and it should be comprehended that all of the preferred embodiments of the present invention are provided only for illustrating but not for limiting the Claims of the present invention. It should also be understood by the person having ordinary skill in the art that the present invention may be performed without one or more specific details or other specific methods. The present invention may be applied to various kinds of fibers, which will be discussed hereinafter.

The method of the present invention prepares a model with computer-aided design or computer modeling software first, and then divides the model into layer-by-layer cross-sections. The standard file format in the cooperation may be STL(standard triangle language) file format. A STL file utilizes triangle facets to substantially simulate the surfaces of an article. The smaller the triangle facets are, the higher the generated surface resolutions will be. VRML(Virtual Reality Modeling Language) or WRL file may also be employed.

The cross-section information of each layer or cross-section in the file may be read by a spraying device, and the cross-sections are sprayed and deposited layer by layer with liquid or powder material, where part of cross-section information may include the information of three-dimensional features on the interior surface. The thickness and the resolution in the direction of plane, i.e. X-Y direction of the cross-sections deposited by the spraying device are calculated in dpi, nanometer or micrometer. Generally, the thickness thereof may be about 10 micrometers to 100 micrometers, i.e. 0.1 millimeters. A device which can spray a layer of the thickness of 16 micrometers may also be utilized depending upon the needs and the resolution.

The spraying diameter thereof generally may be about 50 to 100 micrometers, and the time needed relies upon the size and the complexity of the article.

Different materials may be processed with different spraying devices, and the objects may be established with different layers. Some techniques fabricate the sprayed solution by melting or softening plastic materials, such as selective laser sintering and fused deposition modeling. Alternatively, there may be techniques which utilize liquid material as the sprayed material, for example SLA (StereoLithography Apparatus) and LOM (Laminated object manufacturing). Generally, the spraying speed, the cost, the material and the color choice need to be considered. For instance, the selective laser sintering (SLS) is adapted to thermoplastic material, metal powder and ceramic powder. The direct metal laser sintering (DMLS) is adapted to alloy; fused deposition modeling (FDM) is adapted to thermoplastic material, eutectic system metal and edible material; the digital light processing (DLP) is applied to resin; fused filament fabrication (FFF) is adapted to ABS (Acrylonitrile butadiene styrene) resin; laminated object manufacturing (LOM) is applied to paper, metal film and thin plastic film.

The aforementioned sprayed material may be employed to deposit layer by layer, and may be adhered layer by layer to constitute the object, so as to form three-dimensional patterns on the interior surface without the use of injection molding, demolding and trimming procedures and be adapted to numerous kinds of materials. The present invention rapidly forms the stacked layer by additive manufacturing (AM) and directly manufactures based on digital model files, so as to fabricate objects of arbitrary shapes on the interior surface. The present invention employs the material which can be adhered, such as powdered or liquid plastic material, metal powder, ceramic powder, resin, etc, and additively manufactures by layer-by-layer stacking and accumulation methods which are different from the traditional mechanical working method, where the latter usually employs cutting or drilling techniques, i.e. material decrease manufacturing process. The article may include cups, bowls, kettles, bottles, pans, tubs, spheres, lampshades and light bulbs.

The present invention is described above with the preferred embodiments. However, it should be appreciated that this embodiment is described not for limiting the Claims of the present invention. Numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A method of forming a three-dimensional object on an interior surface of an article, comprising:
preparing a model with computer-aided design or computer software and dividing said model into layer-by-layer cross-section files;
reading cross-section information in said layer-by-layer cross-section files by a spraying device, wherein part of said cross-section information includes interior surface three-dimensional object information;
spraying and depositing liquid or powdered sprayed material layer by layer according to said cross-section information by said spraying device to form cross-sections; and
depositing and adhering said sprayed material layer by layer to form an article and depositing an interior surface three-dimensional object on an interior surface of said article according to said interior surface three-dimensional object information by said spraying device without use of injection molding, demolding and trimming procedures.

2. The method of claim 1, wherein said layer-by-layer cross-section files employ standard triangle language (STL) file format, virtual reality modeling language (VRML) file format or WRL file format.

3. The method of claim 2, wherein a spraying diameter of said spraying is about 50 to 100 micrometers.

4. The method of claim 2, wherein said spraying utilizes selective laser sintering, fused deposition modeling, stereolithography apparatus, laminated object manufacturing, direct metal laser sintering, digital light processing or fused filament fabrication.

5. The method of claim 2, wherein said sprayed material is thermoplastic material, metal powder, ceramic powder, alloy, resin, paper, metal film or thin plastic film.

6. The method of claim 2, wherein said article includes cups, bowls, kettles, bottles, pans, tubs, spheres, lampshades or light bulbs.

7. The method of claim 1, wherein a thickness of said cross-sections is about 10 micrometers to 100 micrometers.

8. The method of claim 7, wherein a spraying diameter of said spraying is about 50 to 100 micrometers.

9. The method of claim 7, wherein said spraying utilizes selective laser sintering, fused deposition modeling, stereolithography apparatus, laminated object manufacturing, direct metal laser sintering, digital light processing or fused filament fabrication.

10. The method of claim 7, wherein said sprayed material is thermoplastic material, metal powder, ceramic powder, alloy, resin, paper, metal film or thin plastic film.

11. The method of claim 7, wherein said article includes cups, bowls, kettles, bottles, pans, tubs, spheres, lampshades or light bulbs.

12. The method of claim 1, wherein a spraying diameter of said spraying is about 50 to 100 micrometers.

13. The method of claim 1, wherein said spraying utilizes selective laser sintering, fused deposition modeling, stereolithography apparatus, laminated object manufacturing, direct metal laser sintering, digital light processing or fused filament fabrication.

14. The method of claim 1, wherein said sprayed material is thermoplastic material, metal powder, ceramic powder, alloy, resin, paper, metal film or thin plastic film.

15. The method of claim 1, wherein said article includes cups, bowls, kettles, bottles, pans, tubs, spheres, lampshades or light bulbs.

16. A method of forming a three-dimensional object on an interior surface of a container, comprising:
preparing a model with computer-aided design or computer software and dividing said model into layer-by-layer cross-section files;
reading cross-section information in said layer-by-layer cross-section files by a spraying device, wherein part of said cross-section information includes interior surface three-dimensional object information;
spraying and depositing liquid or powdered sprayed material layer by layer according to said cross-section information by said spraying device to form cross-sections; and
depositing and adhering said sprayed material layer by layer to form an article and depositing an interior surface three-dimensional object on an interior surface of said article according to said interior surface three-dimensional object information by said spraying device without use of injection molding, demolding and trimming procedures; wherein said sprayed material includes thermoplastic material, metal powder, ceramic powder, alloy, resin, paper, metal film or thin plastic film; said container includes cups, bowls, kettles, bottles, pans, tubs, spheres, lampshades or light bulbs.

17. The method of claim 16, wherein a thickness of said cross-sections is about 10 micrometers to 100 micrometers, wherein a spraying diameter of said spraying is about 50 to 100 micrometers.

18. The method of claim 17, wherein said spraying utilizes selective laser sintering, fused deposition modeling, stereolithography apparatus, laminated object manufacturing, direct metal laser sintering, digital light processing or fused filament fabrication.

19. The method of claim 16, wherein said spraying utilizes selective laser sintering, fused deposition modeling, stereolithography apparatus, laminated object manufacturing, direct metal laser sintering, digital light processing or fused filament fabrication.
